(19) United States
(12) Patent Application Publication
(10) Pub. No.: US 2005/0176534 A1
(43) Pub. Date: Aug. 11, 2005

(54) Automatic gearbox with a variator with at least two sets of conical disks

(76) Inventors: Matthias Reisch, Ravensburg (DE); Bernhard Sich, Friedrichshafen (DE); Holger Fahl, Gaggenau (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/514,459

(22) PCT Filed: May 16, 2003
(86) PCT No.: PCT/EP03/05148

(30) Foreign Application Priority Data
May 22, 2002 (DE) 102 22 519.2

(51) Int. Cl. F16H 9/02

(52) U.S. Cl. 474/49

(57) ABSTRACT

An automatic transmission (1) with a variator (5) and with at least two conical disk sets (2, 3) is described, such that a wrap-around element (4) is guided over the conical disk sets (2, 3) for torque transmission with continuously variable transmission ratio. In this, the arrangement of the rotation axes of two conical disks (3A, 3B) of a conical disk set (3) relative to one another can be changed, in that at least a first conical disk (3B) can be tilted relative to a second conical disk (3A) of the conical disk set (3).

The invention concerns an automatic transmission with a variator having at least two sets of conical disks, of the type defined in more detail in the preamble of claim 1.

From the prior art, automatic transmissions are known in the form of continuously variable wrap-around transmissions, in which at least one conical disk of a conical disk set of a variator is made to be able to move axially. The axial movement of the conical disk changes the distance between the conical disks of a conical disk set. This, in turn, changes the respective wrap-around radii of a wrap-around area in which a wrap-around element is guided over a conical disk set. The change of wrap-around radii leads to an adjustment of the transmission ratio. Sufficiently large axial pressure forces between the wrap-around element and the conical disk sets of the variator ensure torque transmission from one conical disk set, via the wrap-around element, to a second conical disk set of the variator.

In a conventional wrap-around transmission, a reaction force which, during operation, results from the strand forces of the wrap-around element, brings about an elastic deformation of the conical disks as the load increases. Moreover, a certain tilting movement cannot be entirely avoided, owing to the presence of some play in the linear guiding which enables the axial movement of an axially movable conical disk.

Due to the elastic deformation of the conical disks and the tilting movement of the axially movable conical disks that results from the guiding play, the conical disks of a conical disk set are “spread apart” by the wrap-around element or by the strand forces exerted on the conical disks by the wrap-around element. This spreading is greatest in a central section of the wrap-around area of the wrap-around element on the two conical disk sets, which leads disadvantageously to a radial slippage of the wrap-around element in the direction of the rotation axis of the conical disks of the conical disk set, i.e. “inward”.

In a run-out area of the wrap-around element, the spreading of the conical disks is smaller than in the aforesaid central section of the wrap-around area. As a result, only by overcoming high pinching forces can the wrap-around element pull free from the respective conical disk set, and this results in an undesirable reduction of the transmission efficiency of the variator or wrap-around transmission and increases the loading of the wrap-around element.

The purpose of the present invention is to provide an automatic transmission characterized by high transmission efficiency and in which the loading of a wrap-around element is reduced in order to prolong its life.

According to the invention, this objective is achieved with an automatic transmission having the characteristics of claim 1.

In the automatic transmission, according to the invention, with a variator and at least two conical disk sets over which a wrap-around element is guided for torque transmission with continuously variable transmission ratio, the feature of being able to change the arrangement of the rotation axes of two conical disk sets by tilting at least one conical disk of one conical disk set relative to a second conical disk of this conical disk set, provides the advantageous possibility of correcting a real wrap-around path of the wrap-around element on a conical disk set, which deviates from an ideal wrap-around path because of the spreading of the conical disk set, in the direction of the said ideal wrap-around path.

In particular, the possibility is provided of counteracting a spread between the conical disks of a conical disk set in a central section of the wrap-around area, in which the spreading is preferably maximum, in an entirely controlled way by tilting at least one conical disk of the conical disk set concerned. This prevents radial slippage of the wrap-around element in the area of the maximum spreading of the conical disks or reduces it to a sufficient extent so that the pinching force on the belt as it moves out of the wrap-around area of the wrap-around element is reduced which, in turn, decreases the loading of the wrap-around element. This reduction of the loading of the wrap-around element increases its life and, as a result, the automatic transmission has longer maintenance intervals.

Other advantages and advantageous design features of this object of the invention emerge from the claims, the description and the drawing.

Several advantageous example embodiments of the automatic transmission according to the invention are illustrated in the drawing in a schematic and simplified way, and will be explained in some detail in the description below, the same indexes being used in the description for the same or functionally equivalent components. The drawing shows:

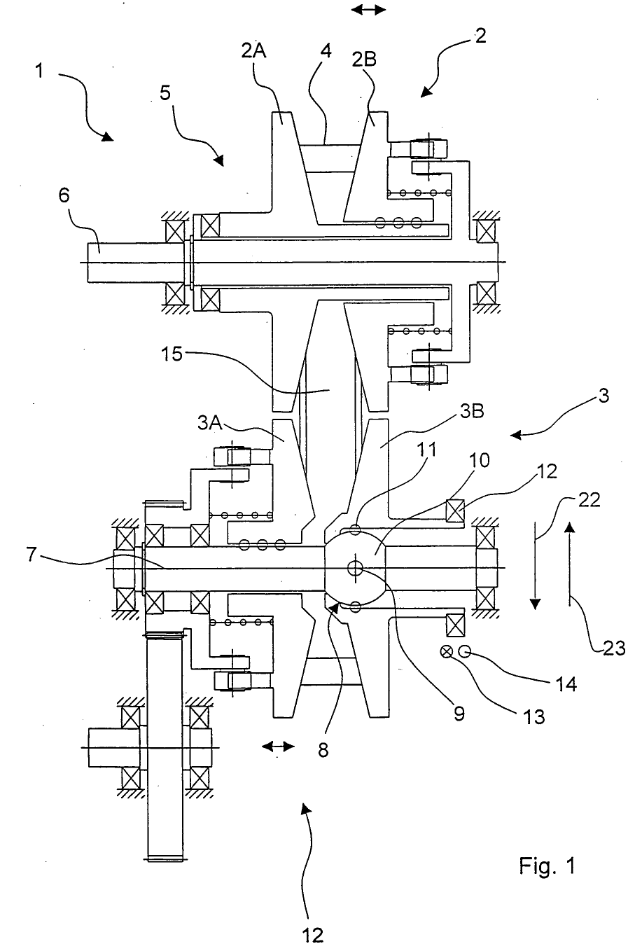

FIG. 1 is a very schematic partial sectional view of a variator of a continuously variable automatic transmission;

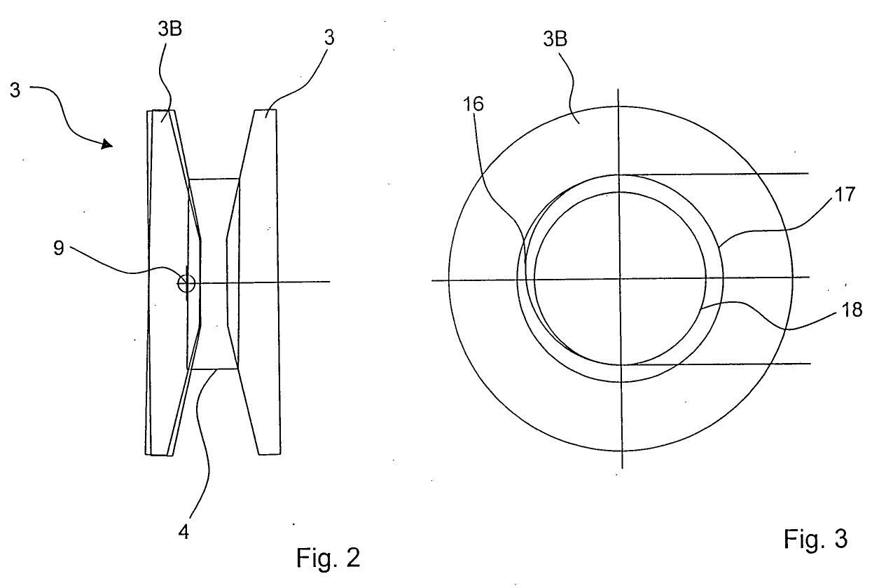

FIG. 2 is a conical disk set of a variator, shown very schematically from one viewpoint;

FIG. 3 is a side view of a conical disk of the conical disk set of FIG. 2;

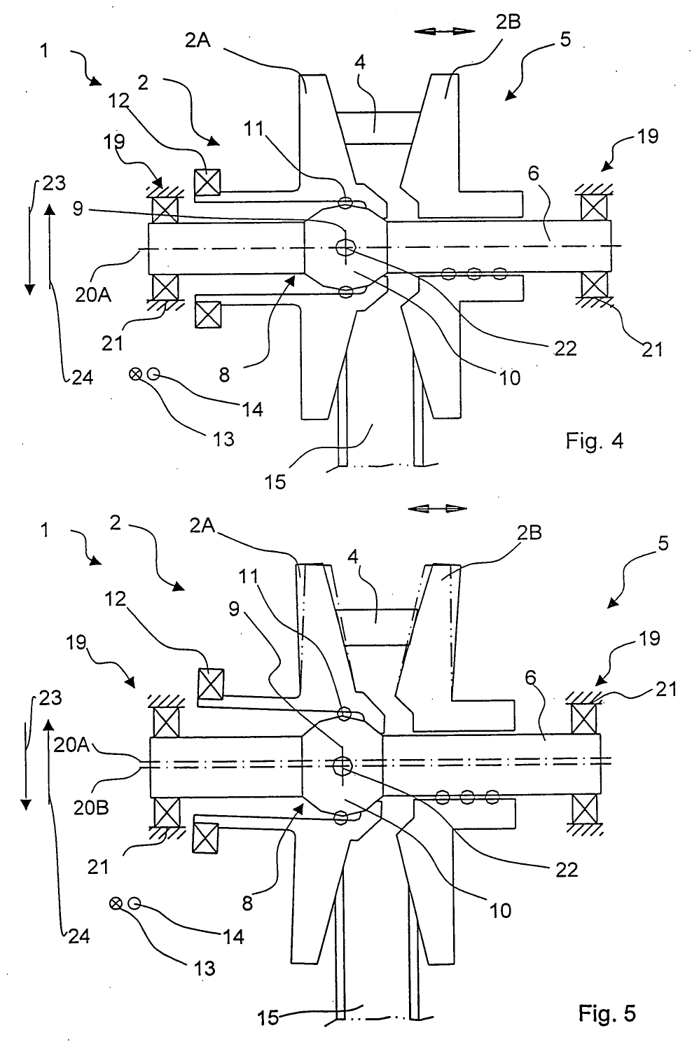

FIG. 4 is a conical disk set of a variator, shown very schematically from one viewpoint;

FIG. 5 is the conical disk set of FIG. 4, showing the displacement of a shaft as the result of high belt strand forces;

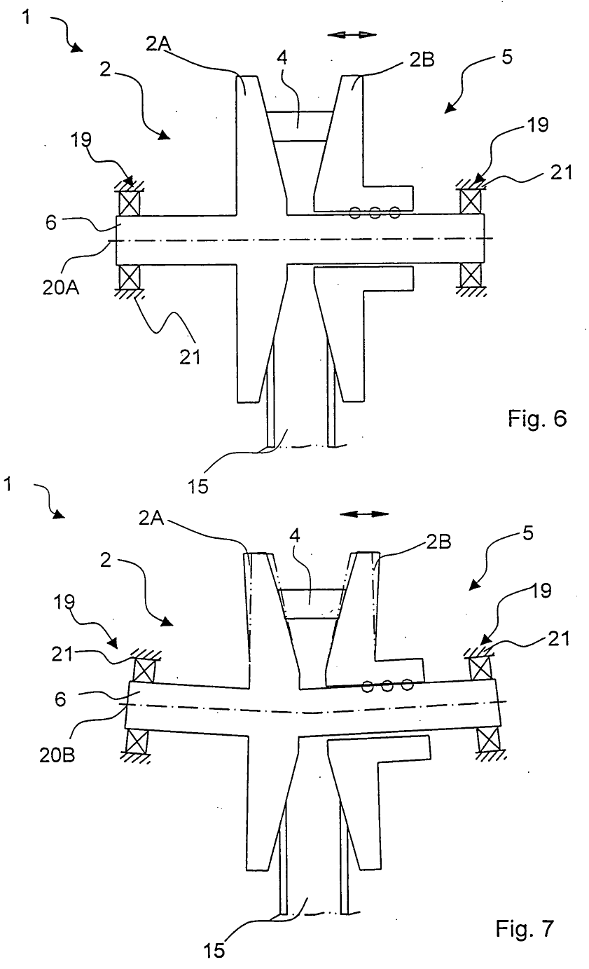

FIG. 6 is another embodiment of a conical disk set of a variator, shown very schematically from one viewpoint; and

FIG. 7 is the conical disk set of FIG. 6, in which a shaft shows a definite sag as the result of high strand forces.

FIG. 1 shows an automatic transmission 1 with two conical disk sets 2 and 3, each having two conical disks 2A, 2B and 3A, 3B, respectively. Between the conical disks 2A, 2B and the conical disks 3A, 3B, a wrap-around element 4 is provided to transfer torque from the first conical disk set 2 to the second conical disk set 3.

The two conical disk sets 2, 3 and the wrap-around element 4 are components of a variator 5 of the automatic transmission 1, in this case formed as a continuously variable wrap-around transmission with a wrap-around element in the form of a dry composite band or belt 4, although the wrap-around element can also be a chain or a thrust-link band. The dry composite belt provided in this case has the advantage compared with chains or thrust-link bands that no oil is needed, and because of this the contact pressures for torque transmission are substantially lower.

In the section of the automatic transmission 1 shown schematically in FIG. 1, the conical disk 2B and the conical disk 3A are arranged so that they can be displaced relative to the conical disk 2A and the conical disk 3B, in the axial direction of their respective shafts 6 and 7 which in this case constitute a drive input shaft 6 and a drive output shaft 7. By changing the distance between the conical disks 2A, 2B or the conical disks 3A, 3B, the transmission ratio can be changed in a manner already known as such, whereby the radii on which the belt 4 runs on the conical disks 2A to 3B change. The adjustment process can be initiated by moving the conical disks 2A, 2B and 3A, 3B towards or away from one another by increasing an axial pressure force exerted by an axial actor (not shown).

To effectively avoid an unacceptably large force increase for transmission ratio adjustment and increase the adjustment speed of the variator 5, the conical disk 3B is mounted rotationally fixed on the drive output shaft 7 on a synchronous-velocity joint 8 and can be tilted about a tilt axis 9.

When the conical disk 3B is tilted, the equidistant corresponding to the width of the belt 4, i.e. the respective contact line of the belt 4 with the two conical disks 3A, 3B of conical disk set 3 in the wrap-around area, which is at least approximately a circle when the conical disk 3B is not tilted, assumes at least approximately the shape of a spiral. Depending on the tilt direction of the conical disk 3B, the belt 4 screws outward or inward to a larger or smaller wrap-around radius or diameter relative to the conical disks 3A, 3B without any substantial increase of an axial pressure force on the belt 4.

The illustrated combination of axial mobility of the conical disks 2B and 3A and the ability of the conical disk 3B to tilt has the result that the variator 5, or the transmission ratio that can be set by the variator 5, can be changed to a desired different transmission ratio at high adjustment speed, the adjustment being effected essentially by the tilting movement of the conical disk 3B and the axial displacement of the conical disks being provided only in a supporting capacity.

Thus, the design of the variator 5 offers the possibility of adjusting the transmission ratio only by a tilting movement of the conical disk 3B, without bringing about an axial displacement of the conical disk 2B and/or of the conical disk 3A.

Thanks to the tilting of the conical disk 3B, namely the possibility of changing the arrangement between the rotation axes of the conical disks 3A, 3B, it is ensured that a transmission ratio adjustment is carried out without the action of unacceptably high pressure forces on the belt and the conical disks 2A to 3B, so that belt wear, undesirably high heat evolution and self-inhibition of the belt 4 are avoided or minimized in a simple manner.

A synchronous-velocity joint 8 is in this case made with a ball-shaped inner joint body 10 over which the conical disk 3B can tilt, so that the synchronous-velocity joint 8 acts as a radial bearing, axial bearing and swivel bearing for the conical disk 3B.

To transfer the torque, between the joint body 10 and the conical disk 3B, several locking elements 11 are provided in the form of hardened and ground balls, which sit in grooves (not shown in greater detail) ground into the surface of the joint body 10 and at the same time engage in the conical disk 3B in order to transfer the torque from the conical disk 3B to the drive output shaft 7.

In an embodiment (not shown) of the automatic transmission according to the invention which deviates from the above, it can also be provided that the locking elements 11 for torque transmission are made as sheet membranes, which are much cheaper to produce since they are neither hardened nor ground.

Further, in another design version of the automatic transmission according to the invention which deviates from the embodiment shown in the drawing, it can be provided that the rotationally fixed but tilt-movement-permitting joint between the conical disk 3B and the drive output shaft 7 is made elastic in such manner that the tilting movement of the conical disk 3B takes place only above a given pressure force between the conical disk 3B and the belt 4.

This counteracts in a simple manner any overload of the belt 4. Moreover, an appropriate design of the elastic joint between the drive output shaft and the conical disk can minimize too large a deviation of the equidistance from their ideal circular shape, and this advantageously increases the efficiency of the variator.

To tilt the conical disk 3B shown in FIG. 1 about its tilt axis 9, an actuator device (not shown) acts upon a bearing 12 so that the conical disk 3B is pushed into or out of the plane of the drawing in directions 13 or 14 represented in the area of the bearing 12 in FIG. 1, whereby the conical disk 3B undergoes a tilting movement about the tilt axis 9.

In addition there is the possibility of adjusting the bearing 12 by means of the actuator device in the direction of and away from the conical disk set 2 on the drive input side, as indicated by direction arrows 23, 24, whereby the conical disk 3B can be tilted about a further tilt axis 22. This further tilt axis 22 is positioned perpendicular to the rotation axis of the conical disk 3A and to the slack or loaded strands 15 of the belt 4A.

In a simple manner, this tilting movement that can be actively controlled by the actuator device counteracts a spreading of the conical disk set 3 or the conical disks 3A, 3B that corresponds to the current transmission ratio set at the variator 5 and to the actual torque transmitted by the variator 5.

The tilting of the conical disk 3B about the further tilt axis 22 in particular reduces or completely compensates a spreading of the conical disks 3A, 3B in a section of the wrap-around area in which the spreading is as a rule maximum. This effectively avoids a radial inward slippage of the belt 4 in the wrap-around area or in the section of the wrap-around area which appears with increasing spread of the conical disks 3A, 3B and, among other things, causes high pinching forces.

Obviously, it can also be provided that a tilting of one conical disk of a conical disk set with the aid of an actuator device to improve the efficiency of the automatic transmission takes place, in which the disk is tilted about a tilt axis arranged perpendicularly to the rotation axis of the tiltable conical disk, and such that the maximum tilt path of the conical disk in the direction of the other conical disk of a conical disk set coincides respectively with the maximum disk spreading of the conical disk set concerned. This means that the position of the further tilt axis varies in each case depending on the direction of a force acting on the conical disk set which results from the strand forces of the belt. In this, an additional tilt of the conical disk to produce a transmission ratio change of the variator in the manner described earlier by means of the actuator device or with a further actuator device, can be provided for.

The actuator device for adjusting the arrangement of the rotation axis of conical disk 3B relative to the rotation axis of conical disk 3A is made as a linear drive and in this case comprises an electric motor with a spindle, to tilt the conical disk 3B about its tilt axis 9 and the further tilt axis 22. The maximum tilt or positional adjustment path of the bearing 12 is in a range from 1/10 mm up to one or a few millimeters, depending on the application in each case.

Alternatively, instead of the electric motor and spindle it is obviously possible to provide a piezoelectric control unit and to produce larger adjustment paths by means of an adjustment path enlarging system arranged between the active element of the piezoelectric unit and the bearing 12.

In the present case the bearing 12 is a grooved ball bearing, whereby any tilting movement of the outer ring of the bearing 12 during the adjustment of the bearing relative to the linear drive is taken up by a coupling element arranged between the spindle and the outer ring of the bearing 12.

If the bearing 12 is made as a self-aligning roller bearing the coupling element is not needed, since tilt movements are compensated by a self-aligning roller bearing.

FIG. 2 shows the conical disk set 3 of FIG. 1, with the conical disk 3B represented at the same time in the untilted and tilted positions. Correspondingly, FIG. 3 shows the change of the run-in radius and the run-out radius of the belt 4 caused by the tilt movement of the conical disk 3B relative to the conical disk 3A, shown in FIG. 2, such that in the tilted position of the conical disk 3B the equidistant 16 has a spiral shape as shown in FIG. 3.

FIG. 3 also shows a circle 17 whose radius corresponds to the wrap-around radius in the run-in area of the belt 4 of the conical disk set 3. Another circle 18, whose radius corresponds to the wrap-around radius of the belt 4 in the run-out area of the conical disk set 3, represents the ideal shape of the equidistant at the end of the transmission ratio adjustment.

Owing to the tilt movement of the conical disk 3B about its tilt axis 9, which is perpendicular to the rotation axis of the conical disk 3B and extends at least approximately parallel to a slack strand or a loaded strand 15 of the belt 4, starting from an aligned arrangement of the rotation axes of the conical disks 3A and 3B to an arrangement in which the rotation axes of conical disks 3A and 3B are at an angle to one another, the belt 4 screws from the radius of the circle 17 toward the radius of the other circle 18 until the shape of the equidistant 16 corresponds to the said other circle 18 and the corresponding transmission ratio is set at the variator 5.

In a further embodiment of the automatic transmission according to the invention it can obviously also be provided that a transmission ratio adjustment and/or an efficiency increase of a variator are brought about solely by the tilting movement of a conical disk, and that an axial adjustment of the conical disks of a conical disk pair, as is necessary for a transmission ratio adjustment in the CVT systems known from the prior art, can be omitted. In this, the conical disks arranged movably in the axial direction respectively on the drive input and drive output shafts are combined with a so-termed torque ramp by means of which a torque-dependent contact pressure force between the conical disks and the belt 4 is adjusted.

In the embodiment of the automatic transmission 1 illustrated in the drawing an axial contact pressure force between the conical disks 2A, 2B and 3A, 3B and the belt 4 is also respectively applied via a torque ramp. The pressure force is produced in proportion to an applied torque and as a function of the adjustment path of the conical disk concerned, and thus also as a function of the currently set transmission ratio, such that the applied torque is transferred to roller elements of the torque ramp in a manner known as such. Owing to the arrangement of the roller elements in the area of the conical disks 2B and 3A, the applied torque is converted to an axial contact pressure force acting on the conical disk sets 2, 3 and the belt 4 without the occurrence of a transmission ratio change during this.

Moreover, it is also possible for more than one conical disk of the variator to be designed to tilt. Thus, it can easily be provided that both disks of a conical disk set are made to tilt.

Furthermore, it is obviously a matter for the discretion of a person with knowledge of the field to construct an automatic transmission according to the invention with a variator in which at least one conical disk can move in translation in the radial direction of the conical disks and/or a rotation axis of one conical disk can move with a wobbling or oscillating motion relative to the rotation axis of the second conical disk of a conical disk set, so that the arrangement of the rotation axes of the two conical disks of a conical disk set is varied and a transmission ratio adjustment is carried out and/or, in general, the efficiency of the automatic transmission is improved.

Here, an actuator device which actuates the conical disk can appropriately be provided with an eccentric drive.

In addition, in a variant embodiment it can also be provided that the individual conical disks are made to be movable also in the axial direction by means of preferably hydraulic control elements, in order to vary a perpendicular distance between the conical disks of a conical disk set in a manner known as such and thereby increase the adjustment speed of the variator still further.

Essentially, it is up to the discretion of a person with knowledge of the field to combine the various options described above for varying the arrangement of the rotation axes of the two conical disks of a disk set relative to one another, appropriately as a function of the application in each case, such that the conical disks can be made tiltable and/or adjustable in the radial direction of the conical disks and/or with rotation axes that can wobble or oscillate and/or so that the disks can be displaced axially.

Referring now to FIG. 4, the conical disk set 2 of the variator 5 is shown with a conical disk 2B that can move in the axial direction and a conical disk 2A that can tilt. In this, a bearing 19 of the drive input shaft 6 is made elastic in such manner that with increasing strand forces of the belt 4 the drive input shaft 6 and so too the conical disk set 2 are pushed toward the other conical disk set 3 (not shown in FIG. 4).

FIG. 5 shows the conical disk set 2 in a displaced position compared with that shown in FIG. 4, this displacement being caused by high strand forces acting on the conical disks. To clarify the changed position of the drive input shaft 6 compared with FIG. 4, in FIG. 5 a rotation axis of the drive shaft 6 is shown respectively in its original position 20A and in the new, displaced position 20B.

The displacement of the drive input shaft 6 results from an elastic deformation of a bearing housing 21 of the bearing 19. The bearing 12 decoupled from the bearing 19 of the drive shaft 6 remains at least approximately in its original position, so that the conical disk 2A is tilted about a further tilt axis 22 in the manner shown in FIG. 5. The said further tilt axis 22 is perpendicular to the rotation axis of conical disk 2A and to the slack strand or loaded strand 15 of the belt 4.

The displacement of the drive input shaft 6 shown in FIG. 5 is the displacement that can be depicted in the plane of the drawing, with the said displacement of the drive shaft 6 taking place in the direction of the resultant force given by the sum of all the strand and wrap-around forces occurring in the wrap-around area of the conical disk set 2. The direction of this resultant force can point anywhere in space such that the main direction of its action is toward the other conical disk set 3 (not shown).

Owing to the spherical structure of the synchronous-velocity joint, when the drive input shaft 6 is displaced there occurs a corresponding tilt of the conical disk 2A, which counteracts a spiral course of the belt 4 between the two conical disks 2A, 2B that is caused by spreading of the conical disks which leads to losses and reduces the efficiency of the automatic transmission. The spreading of the conical disks 2A, 2B takes place because of high belt strand forces and the component elasticities of the conical disks 2A, 2B in FIG. 5, in which the dot-dash lines reproduce the positions of the conical disks 2A, 2B shown in FIG. 4 and the continuous lines show the conical disks 2A, 2B in their deformed condition.

With increasing strand forces, the defined elastic deformability of the bearing housing 21 of the bearing 19 of the drive input shaft 6 brings about a nominal disk pre-tilt which is a function of the disk spreading to be expected. The expected spreading of the conical disks 2A, 2B depends in each case on the currently set transmission ratio at the variator 5 and the strand forces. The strand forces are supported by the bearing 19 of the drive input shaft 6 and the bearing (not shown) of the drive output shaft 7.

The embodiment of the automatic transmission 1 gives a direct relationship between the axial forces of the drive input and drive output shafts 6 and 7 and a disk pre-tilt, with which the radially inward slippage of the belt 4 and the high pinching forces resulting therefrom are avoided by simple means. This considerably reduces the loading of the belt 4 so that belt wear is decreased and the life of the belt is increased.

The pre-tilt of the disks is adjusted such that a real course of the belt 4 in the wrap-around area of the conical disk set 2, which has a negative effect on the life of the belt 4, is changed toward an ideal, preferably semicircular-shaped course in the wrap-around area.

A further embodiment of the automatic transmission 1 is shown in FIGS. 6 and 7, the conical disk set 2 being shown in FIG. 6 in a condition of low torque transfer and small strand forces. This corresponds to negligible deformation of the drive input shaft 6, so that the conical disks 2A, 2B are at least approximately parallel to one another. In this case the conical disk 2A is made integrally with the drive input shaft 6 and the conical disk 2B can be displaced in the axial direction of the drive shaft 6 and is arranged rotationally fixed to the shaft 6. The axial displacement of the conical disk 2B is effected by an actuator (not shown), in order to enable a desired or necessary transmission ratio adjustment to be carried out by the conical disk set 2 and hence by the variator 5.

If the torque to be transmitted increases, the strand forces of the belt 4 acting on the conical disk set 2 also increase, and this results in a corresponding elastic deformation of the drive input shaft 6. The elastic deformation of the drive input shaft 6 results in tilting of the two conical disks 2A, 2B, leading to the change of their positions shown in FIG. 7. In addition, it can be seen from the representation of FIG. 7 that because of their component elasticities and the strand forces, the conical disks 2A, 2B undergo additional elastic deformation. For a clearer understanding, the untilted and undeformed conditions of the conical disks 2A, 2B are indicated in FIG. 7 by dot-dash lines. At the same time the full-line representation of the conical disks 2A, 2B shows their new positions and deformed conditions.

The respective disk spreading, shown in FIGS. 5 and 7, expected during the operation of the automatic transmission 1 depends on the currently set transmission ratio of the variator and the strand forces occurring, such that by virtue of an elastic deformation of the drive input shaft 6 that corresponds to the loading of the components of the variator 5, a defined disk pre-tilt can be set. For this, in particular a plane moment of inertia of the drive input shaft as a function of its length, that is to say a variation of the plane moment of inertia of the drive input shaft 6 in the axial direction thereof, is established in such manner that a disk pre-tilt which increases the efficiency of the variator 5 takes place as a function of a sag or deformation of the drive input shaft 6, which in turn depends on the currently set transmission ratio and the strand forces. The said variation of the plane moment of inertia of the drive input shaft 6 can be produced by a corresponding diameter design of the shaft 6, by a hollow shaft profile, or by other appropriate design measures.

In all the illustrated embodiments of an automatic transmission according to the invention, a spiral course of the belt in the wrap-around area of the conical disk sets 2, 3 is advantageously deliberately reduced or, for adjustment of the transmission ratio, produced in a controlled way, in such manner that the variator 5 or automatic transmission 1 operates with higher efficiency and as a result the fuel consumption of a vehicle can be reduced. Moreover, the reduction of the pinching forces decreases the heating of the belt 4 so that the belt 4 as a whole can withstand higher loads. This advantageously also enables higher torques to be transferred via the variator 5 from the drive input shaft 6 to the drive output shaft 7. In addition, the reduced belt wear extends the life of the belt 4.

Reference Numerals

1 Automatic transmission
2 Conical disk set
2A,B Conical disks
3 Conical disk set
3A,B Conical disks
4 Belt
5 Variator
6 Drive input shaft
7 Drive output shaft
8 Synchronous-velocity joint
9 Tilt axis
10 Joint body
11 Locking elements
12 Bearing
13 Adjustment direction
14 Adjustment direction
15 Slack strand, loaded strand
16 Equidistant
17 Circle
18 Further circle
19 Bearing
20A,B Rotation axis of the drive input shaft
21 Bearing housing
22 Further tilt axis
23 Direction arrow
24 Direction arrow

1-10. (canceled)

11. An automatic transmission (1) with a variator (5) and at least two conical disk sets (2, 3), with a wrap-around element (4) guided over the at least two conical disk sets (2, 3) for torque transmission with continuously variable transmission ratio, and in which an arrangement of rotation axes of first and second conical disks (2A, 2B or 3A, 3B) of a respective first and second conical disk set (2 or 3) relative to one another can be changed in that at least the first conical disk (2A or 3B) can tilt relative to the second conical disk (2B or 3A) of a respective conical disk set, wherein the first conical disk (2A, 3B) can tilt about a first and a second tilt axis (9, 22), the first tilt axis (9) being arranged perpendicularly to the rotation axis of the first conical disk (2A, 3B) and at least approximately parallel to a slack or a loaded strand (15) of the wrap-around element (4), and the second tilt axis (22) being arranged perpendicularly to the rotation axis of the first conical disk (2A, 3B) and perpendicularly to the slack or loaded strand (15) of the wrap-around element (4).

12. The automatic transmission according to claim 11, wherein an actuator device is provided on a bearing (12) for active tilting of one of the first or second conical disk (2A, 3B) about the first or second tilt axis (9, 22).

13. The automatic transmission according to claim 11, wherein both the first conical disk (2B) can tilt relative to the second conical disk (2A) and the second conical disk (2A) can tilt relative to the first conical disk (2B).

14. The automatic transmission according to claim 11, wherein at least one of the first and second conical disks (2A, 2B or 3A, 3B) of the respective first and second conical disk set (2 or 3) tilts only above a certain contact pressure force between the first and second conical disks (2A, 2B or 3A, 3B) and the wrap-around element (4).

15. The automatic transmission according to claim 11, wherein one of the tiltable first or second conical disk (2A, 2B or 3A, 3B) is in rotationally fixed connection with a respective shaft (6 or 7).

16. The automatic transmission according to claim 15, wherein the rotationally fixed connection is in the form of a synchronous-velocity joint.

17. The automatic transmission according to claim 15, wherein the rotationally fixed connection is made by means of a membrane.

18. The automatic transmission according to claim 11, wherein a bearing (19) of the shaft (6) is made elastic such that varying strand forces of the wrap-around element (4) bring about a change in the position of the shaft (6) and hence of the arrangement of the rotation axes of the two conical disks (2A, 2B) of the first conical disk set (2).

19. The automatic transmission according to claim 11, wherein a variation of a plane moment of inertia of a shaft (6) in an axial direction of the shaft (6) is provided, such that varying strand forces of the wrap-around element (4) bring about a corresponding sag of the shaft (6) and a change in the arrangement of the rotation axes of the conical disks (2A, 2B) of a conical disk set (2) relative to one another.

20. The automatic transmission according to claim 18, wherein the change of the rotation axes of the conical disks (2A, 2B) of the conical disk set (2) as a function of the strand forces of the wrap-around element takes place in such manner that a spiral path of the wrap-around element (4) in a wrap-around area of the first conical disk set (2) can be at least approximately compensated.
